(19) United States
(12) Patent Application Publication
(10) Pub. No.: US 2002/0057170 A1
(43) Pub. Date: May 16, 2002

(54) IGNITION COIL

(76) Inventors: ALBERT ANTHONY SKINNER, ANDERSON, IN (US); KENNETH P. SENSEMAN, NOBLESVILLE, IN (US); VIOREL N. MOGA, ANDERSON, IN (US)

Correspondence Address: MARGARET A DOBROWITSKY, DELPHI TECHNOLOGIES INC, P O BOX 5052, MAIL CODE 480 414 420, TROY, MI, 480075052

(21) Appl. No.: 09/435,046

(22) Filed: Nov. 8, 1999

(51) Int. Cl. H01F 27/02

(52) U.S. Cl. 336/198

(57) ABSTRACT

An ignition coil (10) has a core (16) composed of a plurality of laminations (46) and about which is directly disposed an insulating layer (22). A primary winding (24) is wound directly on the insulating layer (22), thereby eliminating the need for a primary winding spool and recovering the space conventionally occupied by such a primary winding spool for use in allocating greater space to the core (16) and/or windings.

### BACKGROUND OF THE INVENTION

1. Field of the Invention

The present invention relates generally to ignition coils for developing a spark firing voltage that is applied to one or more spark plugs of an internal combustion engine.

2. Description of the Related Art

Ignition coils utilize primary and secondary windings and a magnetic circuit. The magnetic circuit may include a core formed of steel laminations, as disclosed in U.S. Pat. No. 5,870,012 to Sakamaki et al. Sakamaki et al. disclose an ignition coil having a relatively slender configuration adapted for mounting directly above a spark plug—commonly referred to as a “pencil” coil. The ignition coil of Sakamaki et al. has a core composed of laminations of iron plates nearly circular in radial cross-section. Sakamaki et al. further disclose a bobbin disposed radially outwardly of the core having a primary coil wound thereon, another bobbin disposed radially outwardly of the primary coil having a secondary coil wound thereon, and a case disposed outwardly of the secondary coil. The bobbin upon which the primary coil is wound protects the primary coil from the sharp edges of the laminations, in addition to providing a structure for retaining the primary coil.

A problem, however, arises from the configuration disclosed in Sakamaki et al. Particularly, inasmuch as the bobbin must be configured to withstand the pressure from the winding tension, among other things, it must have a predetermined minimum thickness (e.g., typically about 1 mm), which occupies valuable space in such an ignition coil. This has the result of a larger ignition coil. Alternatively, if there are restrictions or limitations on the outside diameter of the ignition coil, the space occupied by the primary bobbin displaces, in-effect, space or volume occupied by other components. Thus, core volume may be reduced accordingly, thereby reducing ignition coil performance, or, perhaps requiring that expensive magnets be included in the magnetic circuit to meet performance requirements.

It is also known to dispose a primary coil directly on a core formed by compression molding plastic coated iron particles, as disclosed in U.S. Pat. No. 5,706,792 to Boyer et al. However, an ignition coil having a core composed of steel laminations is a desirable and useful configuration in many instances.

There is therefore a need to provide an improved ignition coil having a core composed of laminations that minimizes or eliminates one or more of the shortcomings as set forth above.

### SUMMARY OF THE INVENTION

An ignition coil in accordance with the present invention is characterized by the features specified in claim 1.

An ignition coil in accordance with the present invention eliminates the need for a primary winding spool by utilizing a non self-supporting insulating layer on the core. Eliminating the primary winding spool used in conventional designs provides increased space for core area and/or copper (e.g., windings), thereby allowing increased performance. Eliminating the primary winding spool also provides for a lower cost core structure in certain instances, inasmuch as the increased core area and/or copper may improve performance to such a degree that magnetic biasing by way of expensive magnets may be eliminated. The additional space may also be used for increased encapsulant and/or plastic wall thickness in the ignition coil structure, which improves quality.

An ignition coil in accordance with the invention includes a magnetically permeable core having a main axis, a primary winding disposed radially outwardly of the core, a secondary winding spool formed of electrical insulating material disposed radially outwardly of the primary winding, a secondary winding wound on the secondary winding spool, and a case and a shield disposed radially outwardly of the secondary winding, characterized by: an insulating layer comprising electrical insulating material that is non self-supporting disposed directly on the core, the core having a plurality of iron laminations; wherein the primary winding is wound directly on the insulating layer.

### BRIEF DESCRIPTION OF THE DRAWINGS

The present invention will now be described by way of example, with reference to the accompanying drawings, in which:

FIG. 1 is a simplified, cross-section view of an ignition coil in accordance with the present invention;

FIG. 2 is an enlarged, exaggerated cross-section view of a laminated core/insulated layer portion of the ignition coil of FIG. 1 taken substantially along lines 2-2; and,

FIG. 3 is a flowchart diagram of a method of manufacturing an ignition coil according to the invention.

### DETAILED DESCRIPTION OF THE PREFERRED EMBODIMENT

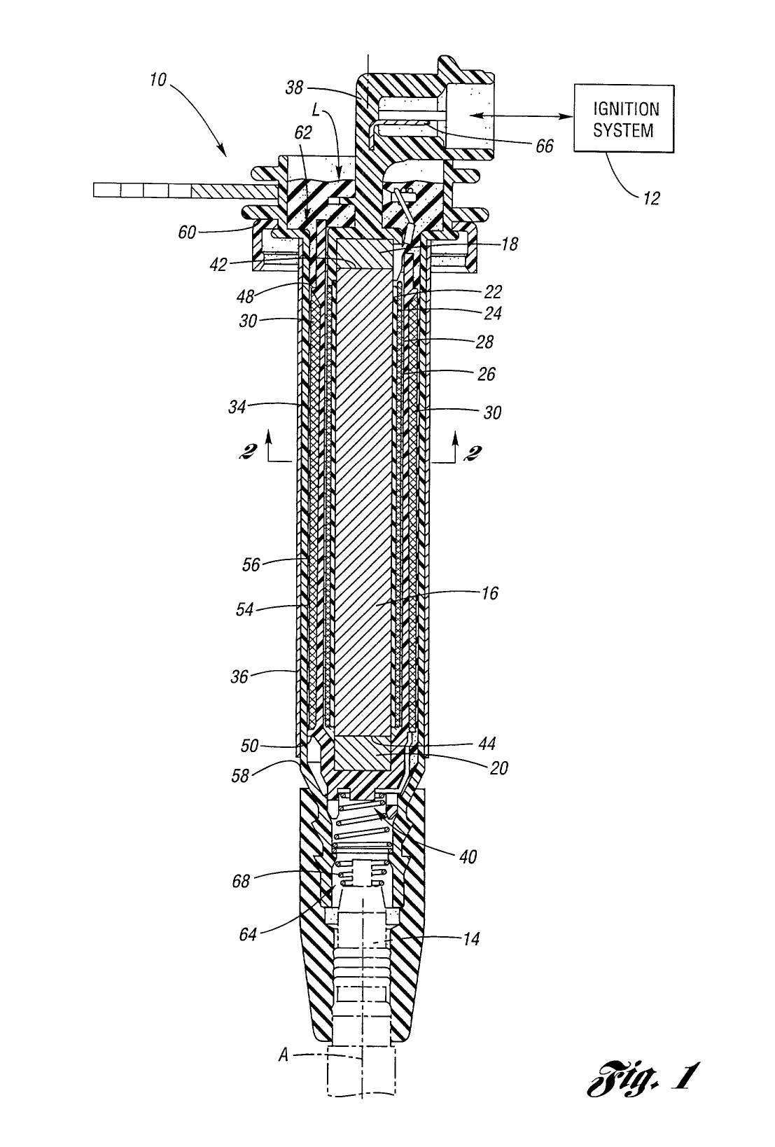

Referring now to the drawings wherein like reference numerals are used to identify identical components in the various views, FIG. 1 is a simplified, cross-section view of an ignition coil 10 in accordance with the present invention. As is generally known, ignition coil 10 may be coupled to, for example, an ignition system 12, which contains primary energization circuitry for controlling the charging and discharging of ignition coil 10. Further, also as is well known, the relatively high voltage produced by ignition coil 10 is provided to a spark plug 14 (shown in phantom-line format) for producing a spark across a spark gap thereof, which may be employed to initiate combustion in a combustion chamber of an engine. Ignition system 12 and spark plug 14 perform conventional functions well known to those of ordinary skill in the art.

Ignition coil 10 is adapted for installation to a conventional internal combustion engine through a spark plug well onto a high-voltage terminal of spark plug 14, which may be retained by a threaded engagement with a spark plug opening into the above-described combustion cylinder. Ignition coil 10 comprises a substantially slender high voltage transformer including substantially, coaxially arranged primary and secondary windings and a high permeability magnetic core.

Referring to FIG. 1, in accordance with the invention, ignition coil 10 includes a core 16, a first magnet 18, a second magnet 20, an insulating layer 22, a primary winding 24, a first epoxy potting material layer 26, a secondary winding spool 28, a secondary winding 30, a second epoxy potting material layer 32, a case 34, a shield 36, a low-voltage (LV) connector body 38, and a high-voltage (HV) connector assembly 40.

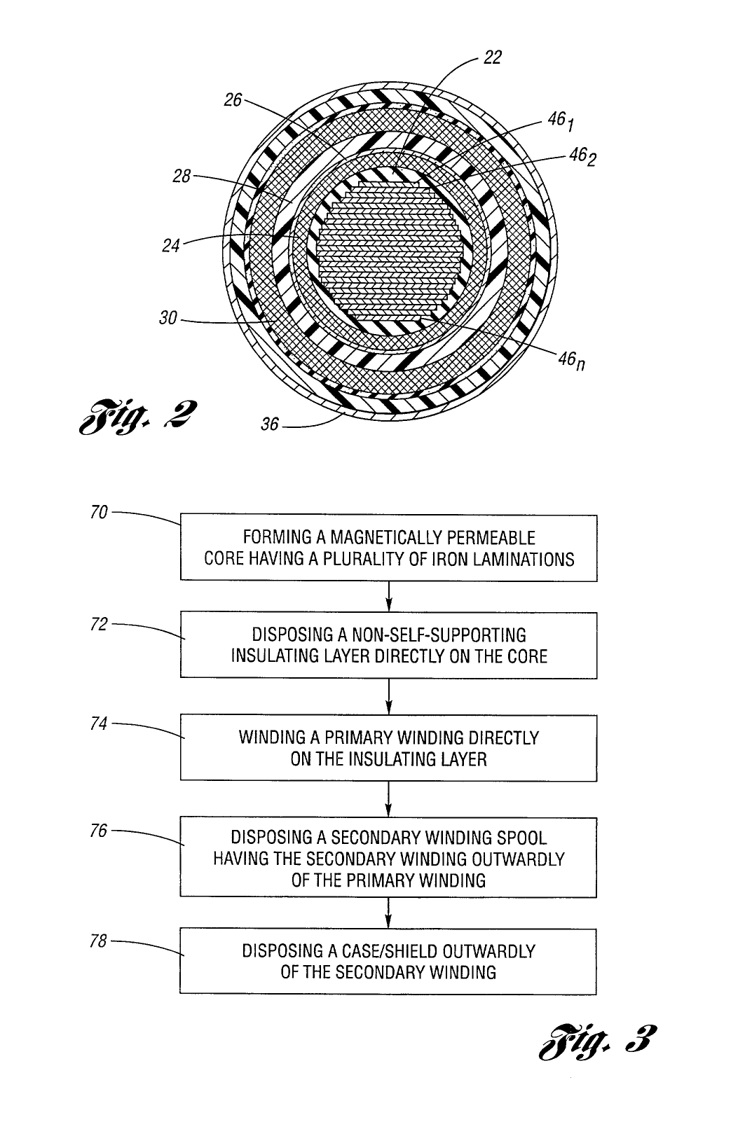

Core 16 may be elongated, having a main, longitudinal axis AA≅ associated therewith. Core 16 includes an upper, first end 42, and a lower, second end 44. Core 16 comprises magnetically permeable material, for example, a plurality silicon steel laminations 46₁, 46₂, . . . , 46ₙ, (best shown in FIG. 2). In one embodiment, core 16 comprises 20-30 of such laminations. Core 16 may be a conventional core known to those of ordinary skill in the art. As illustrated, core 16, in the preferred embodiment, takes a generally cylindrical shape (which is a generally circular shape in radial cross-section).

Magnets 18 and 20 are included in ignition coil 10 as part of the magnetic circuit, and provide a magnetic bias for improved performance. The construction of magnets such as magnets 18 and 20, as well as their use and effect on performance, is well understood by those of ordinary skill in the art. It should be understood that magnets 18 and 20 are optional in ignition coil 10, and may be omitted, albeit with a reduced level of performance, which may be acceptable, depending on performance requirements.

FIG. 2 is a cross-sectional, exaggerated and enlarged view of insulating layer 22. Insulating layer 22 comprises electrical insulating material that is non self-supporting. Layer 22 is disposed directly on core 16. The principal function of layer 22 is to protect the primary winding from the sharp edges of the steel laminations 46. That is, layer 22 is configured to stop the copper of primary winding 24 from contacting core 16 (which may be grounded). Layer 22 may comprise a plurality of materials. For example, layer 22 may comprise a polyester film, such as MYLAR® tape or a MYLAR® shrink tube, both commercially available from E. I. du Pont de Nemours and Company, Wilmington, Del., United States. Layer 22 may in the alternative comprise a polyimide film, such as KAPTON® tape, commercially available from, for example, E. I. du Pont de Nemours and Company, Wilmington, Del., United States, or, APICAL® tape, commercially available from KANEGAFUCHI KAGAKU KOGYO KABUSHIKI KAISHA (“Kaneka”), Osaka, Japan. Layer 22 may yet further comprise epoxy based coating powder material, an electrostatic coating, commercially available from The Dexter Corporation, Windsor Locks, Conn., U.S.A. under the product designation HYSOL DK 15EG-05 GREEN. Such powder material provides electrical insulation and offers cut through temperature resistance, and is applied by an electrostatic fluid bed process. Insulating layer 22 may have a thickness between about 0.025 mm and 0.20 mm.

It should be understood, however, that the thickness range set forth above is exemplary rather than limiting in nature. The range set forth above, however, has been found satisfactory based on the materials described above. Other materials, that are non self-supporting, that provide electrical insulating and protection from the sharp edges of laminations 46 may be employed, and may have a corresponding thickness that is less than, or, greater than the range set forth above.

The advantage of the layer 22 is that it eliminates the need for a primary winding spool, such as employed in convention designs, and which may have a typical thickness of about 1.0 mm. The space saved by insulating layer 22 may allocated to providing addition core volume and/or copper volume (e.g., for windings). This additional core/copper results in an improved magnetic circuit, and thus, improved performance of ignition coil 10, all other factors being the same. Alternatively, magnets, such as magnets 18 and 20, may optionally be omitted from the design, depending on the performance requirements, due to the improved performance arising from increased core/copper alone, resulting in cost savings. That is, the increased core volume may allow for magnets not to be used where they may have been required if a relatively thick primary winding spool was used. Finally, the capability of providing more core volume yields more options as to the type of core material to meet a particular design specification.

Non self-supporting herein means material that does not, by itself, provide the capability of carrying the primary windings 24, but rather, relies on the substrate provided by core 16 for carrying the primary winding.

Primary winding 24 is wound directly onto insulating layer 22. Primary winding 24 includes first and second ends and is configured to carry a primary current I_{P} for charging coil 10 upon control of ignition system 12. Winding 24 may be implemented using known approaches and conventional materials.

Layers 26, and 32 comprise epoxy potting material. The potting material 24 may be introduced into potting channels defined (i) between primary winding 24 and secondary winding spool 28, and, (ii) between secondary winding 30 and case 34. The potting channels are filled with potting material, in the illustrated embodiment, up to approximately the level designated “L” in FIG. 1. The potting material performs the function of electrical insulation and, provides protection from environmental factors which may be encountered during the service life of ignition coil 10. There are a number of suitable epoxy potting materials well known to those of ordinary skill in the art.

FIG. 1 shows a partial cross-sectional view of secondary winding spool 28. Secondary winding spool 28 is configured to receive and retain secondary winding 30. Spool 28 is disposed adjacent to and radially outwardly of the central components comprising core 16, insulating layer 22, primary winding 24, and epoxy potting layer 26, and, preferably, is in coaxial relationship therewith. Spool 28 may comprise any one of a number of conventional spool configurations known to those of ordinary skill in the art. In the illustrated embodiment, spool 28 is configured to receive one continuous secondary winding (e.g., progressive winding), as is known. However, it should be understood that other configurations may be employed, such as, for example only, a configuration adapted for use with a segmented winding strategy (e.g., a spool of the type having a plurality of axially spaced ribs forming a plurality of channels 36 therebetween for accepting windings) as known.

The depth of the secondary winding in the illustrated embodiment decreases from the top of spool 28 (i.e., near the upper end 42 of core 16), to the other end of spool 28 (i.e., near the lower end 44) by way of a progressive gradual flare of the spool body. The result of the flare or taper is to increase the radial distance (i.e., taken with respect to axis “A”) between primary winding 24 and secondary winding 30, progressively, from the top to the bottom. As is known in the art, the voltage gradient in the axial direction, which increases toward the spark plug end (i.e., high voltage end) of the secondary winding, may require increased dielectric insulation between the secondary and primary windings, and, may be provided for by way of the progressively increased separation between the secondary and primary windings.

Spool 28 is formed generally of electrical insulating material having properties suitable for use in a relatively high temperature environment. For example, spool 28 may comprise plastic material such as polybutylene terephthalate (PBT) thermoplastic polyester. It should be understood that there are a variety of alternative materials which may be used for spool 28 known to those of ordinary skill in the ignition art, the foregoing being exemplary only and not limiting in nature.

Spool 28 may further include a first annular feature 48 and a second annular feature 50 formed at axially opposite ends thereof. Features 48, and 50 may be configured so as to engage an inner surface of case 34 to locate, align, and center the spool 28 in the cavity of case 34.

In addition, the body portion of spool 28 tapers on a lower end thereof to a reduced diameter, generally cylindrical outer surface sized to provide an interference fit with respect to a corresponding through-aperture at the lower end of case 34. In addition, the spool body includes a blind bore or well at the spark plug end configured in size and shape to accommodate the size and shape of HV connector assembly 40. In connection with this function, spool 28 may be formed having an electrically conductive (i.e., metal) high-voltage (HV) terminal (not shown) disposed therein configured to connect a high voltage lead of secondary winding 30 to the HV connector assembly 40.

FIG. 1 shows secondary winding 30. Secondary winding 30, as described above, is wound on spool 28, and includes a low voltage end and a high voltage end. The low voltage end may be connected to ground by way of a ground connection through LV connector body 38 in a manner known to those of ordinary skill in the art. The high voltage end is connected to the above-described (HV) terminal 52 for electrically connecting the high voltage generated by secondary winding 30 to HV connector assembly 40 for firing spark plug 14. As known, an interruption of a primary current Iₚ through primary winding 24, as controlled by ignition system 12, is operative to produce a high voltage at the high voltage end of secondary winding 30. Winding 30 may be implemented using conventional approaches and material known to those of ordinary skill in the art.

FIG. 1 shows a cross-sectional, enlarged view of case 34. Case 34 includes an inner, generally cylindrical surface 54, an outer surface 56, a first annular shoulder 58, a flange 60, an upper through-bore 62, and a lower through bore 64.

Inner surface 54 is configured in size to receive and retain the core 16/insulating layer 22/primary winding 24/spool 28/secondary winding 30 assembly. The inner surface 54 of case 34 may be slightly spaced from spool 28, particularly the annular spacing features 48, 50 thereof (as shown), or may engage the spacing features 48, 50.

Annular shoulder 58, and flange 60 are located near the lower, and upper ends of case 34, respectively. Shoulder 58 is formed in size and shape to engage and support a bottommost circumferential edge of shield 36. Likewise, flange 60 is configured in size and shape to engage and support an uppermost circumferential edge of shield 36.

Bore 62 is configured in size and shape to receive the combined assembly of core 16/insulating layer 22/primary winding 24/spool 28/secondary winding 30.

Bore 64 is defined by an inner surface thereof configured in size and shape (i.e., generally cylindrical) to provide an interference fit with an outer surface of spool body 28 (i.e., a lowermost portion thereof), as described above. When the lowermost body portion of spool 28 is inserted in bore 64, therefore, a seal is made.

Case 34 is formed of electrical insulating material, and may comprise conventional materials known to those of ordinary skill in the art (e.g., the PBT thermoplastic polyester material referred to above). Case 34 may nominally be about 1 mm thick.

FIG. 1 further shows a cross-sectional, exaggerated view of shield 36. Shield 36 is generally annular in shape and is disposed radially outwardly of case 34, and, preferably, engages outer surface 56 of case 34. The shield 36 is preferably comprises electrically conductive material, and, more preferably metal, such as steel or other adequate magnetic material. Shield 36 provides not only a protective barrier for ignition coil 10 generally, but, further, provides a magnetic path for the magnetic circuit portion of ignition coil 10. Shield 36 may nominally be about 0.50 mm thick, in one embodiment. Shield 36 may be grounded by way of an internal grounding strap, finger or the like (not shown) well know to those of ordinary skill in the art.

Low voltage connector body 38 is configured to, among other things, electrically connect the first and second ends of primary winding 24 to an energization source, such as, the energization circuitry included in ignition system 12. Connector body 38 is generally formed of electrical insulating material, but also includes a plurality of electrically conductive output terminals 66 (e.g., pins for ground, primary winding leads, etc.). Terminals 66 are coupled electrically, internally through connector body 38, in a manner known to those of ordinary skill in the art, and are thereafter connected to various parts of coil 10, also in a manner generally know to those of ordinary skill in the art. Ignition system 12 may then control energization of the primary winding 24.

FIG. 1 shows a cross-sectional view, with portions broken away, of HV connector assembly 40. HV connector assembly 40 may include a spring contact 68 or the like, which is electrically coupled to HV terminal (not shown) (which is in turn coupled to the high voltage lead of secondary winding 30) disposed in a blind bore portion formed in a lowermost end of spool 28. Contact spring 68 is configured to engage a high-voltage connector terminal of spark plug 14. This arrangement for coupling the high voltage developed by secondary winding 30 to plug 14 is exemplary only; a number of alternative connector arrangements, particularly spring-biased arrangements, are known in the art.

FIG. 3 shows a flowchart of an inventive method of manufacturing an ignition coil 10. In step 70, a core 16 is formed having a plurality of iron laminations. This step is well known in the art.

In step 72, a non self-supporting insulating layer 22 is directly disposed on core 16. This may be accomplished by wrapping (e.g., if the layer 22 is MYLAR® or KAPTON® or other type of tape). Alternatively, step 72 may be accomplished by dipping the core 16 into an electrostatic coating material (e.g., DK 15EG-05 by Dexter Corporation) so as to coat the core 16, then allowing the material to cure in accordance with the manufacturer's instructions. As a further alternative, if the layer 22 is a “shrink tube,” then the heat sensitive tubing material is first disposed over the core 16, then the tubing and core are heated so that the tubing “shrinks” and conforms to the periphery of core 16. The foregoing approaches are exemplary, and not limiting in nature.

In step 74, primary winding 24 is wound directly onto core 16 having the insulating layer 22. This winding process is known to those of ordinary skill in the art.

In step 76, the secondary spool 28 having the secondary winding 30 is disposed outwardly of the core 16/layer 22/primary winding 24 assembly. This step is also known to those of ordinary skill in the art.

Other steps may be performed at this time, such as assembling magnets 18/20, and LV connector body 38.

In step 78, the case 34/shield 36 is disposed outwardly of the foregoing central components. This is commonly done by inserting the central components (e.g., preassembled, which may also include LV connector body 38) through bore 62 in a manner known to those of ordinary skill in the art. Other approaches, however, are known.

Finally, the coil 10 is potted, and all other details of the manufacture are attended to, also as known generally in the art.

An ignition coil in accordance with the present invention eliminates the need for a primary winding spool by utilizing a non self-supporting insulating layer on the core. Eliminating the primary winding spool as used by conventional designs provides increased space for core area and/or copper (e.g., windings), thereby allowing increased performance. Eliminating the primary winding spool also provides for a lower cost core structure in certain instances, inasmuch as the increased core area and/or copper may improve performance to such a degree that magnetic biasing by way of expensive magnets may be eliminated. The additional space may also be used for increased encapsulant and/or plastic wall thickness in the ignition coil structure, which improves quality.

It is to be understood that the above description is merely exemplary rather than limiting in nature, the invention being limited only by the appended claims. Various modifications and changes may be made thereto by one of ordinary skill in the art which embody the principles of the invention and fall within the spirit and scope thereof.

We claim:

1. An ignition coil (10) including a magnetically permeable core (16) having a main axis (“A”) , a primary winding (24) disposed radially outwardly of the core (16), a secondary winding spool (28) formed of electrical insulating material disposed radially outwardly of the primary winding (24), a secondary winding (30) wound on the secondary winding spool (28), and a case (34) and a shield (36) disposed radially outwardly of the secondary winding (30), characterized by:
an insulating layer (22) comprising electrical insulating material that is non self-supporting disposed directly on the core (16), the core (16) having a plurality of iron laminations (46);
wherein the primary winding (24) is wound directly on the insulating layer (22).

2. The coil of claim 1 wherein the core (16) has a shape in radial cross-section that is substantially circular.

3. The coil of claim 1 wherein the insulating layer (22) comprises a polyester film.

4. The coil of claim 1 wherein the insulating layer (22) comprises a polyimide film.

5. The coil of claim 1 wherein the insulating layer (22) comprises an electrostatic coating.

6. The coil of claim 1 wherein the case (34) is formed of electrical insulating material.

7. The coil of claim 1 further comprising a shield (36) disposed radially outwardly of the case (34) and comprising steel material.

8. A method of making an ignition coil (10) comprising the steps of:
(A) forming (70) a magnetically permeable core (16) having a main axis (“A”) wherein the core (16) includes a plurality of iron laminations (46);
(B) disposing (72) an insulating layer (22) comprising electrical insulating material that is non self-supporting disposed directly on the core (16);
(C) winding (74) a primary winding (24) directly on the insulating layer (22) wherein the primary winding (24) is disposed radially outwardly of the core (16);
(D) disposing (76) a secondary winding spool (28) formed of electrical insulating material and having a secondary winding (30) radially outwardly of the primary winding (24); and,
(E) disposing (78) a case (34) and a shield (36) radially outwardly of the secondary winding (30).

9. The method of claim 8 wherein step (B) includes the substep of:
wrapping the core (16) with tape comprising polyester material.

10. The method of claim 8 wherein step (B) includes the substep of:
wrapping the core (16) with tape comprising polyimide material.

11. The method of claim 8 wherein step (B) includes the substeps of:
dipping the core (16) in electrostatic coating material to thereby cover the core (16); and,
curing the electrostatic coating material.

12. The method of claim 8 wherein step (B) includes the substeps of:
disposing a heat sensitive tubing material over the core (16);
heating the tubing material and core so as to cause the tubing to shrink to conform to a periphery of the core (16).
